(19) United States
(12) Patent Application Publication
(10) Pub. No.: US 2026/0112730 A1
(43) Pub. Date: Apr. 23, 2026

(54) Battery Assembly

(71) Applicant: SK On Co., Ltd., Seoul (KR)

(72) Inventors: Yun Kyung MIN, Daejeon (KR); Ji San KIM, Daejeon (KR); Jong Chan LEE, Daejeon (KR)

(21) Appl. No.: 19/362,702

(22) Filed: Oct. 20, 2025

(30) Foreign Application Priority Data
Oct. 21, 2024 (KR) 10-2024-0143636

(51) Int. Cl. H01M 10/653; H01M 10/613; H01M 10/647; H01M 10/6551; H01M 50/211; H01M 50/242

(52) U.S. Cl. CPC H01M 10/653; H01M 10/613; H01M 10/647; H01M 10/6551; H01M 50/211; H01M 50/242

(57) ABSTRACT

Provided is a battery assembly including: a battery housing; a battery cell assembly including a plurality of cells which are stacked and placed in the battery housing and are electrically connected; and a heat dissipation resin layer, and the battery assembly minimizes cell damage due to a swelling phenomenon occurring in a battery cell and has improved module life, by controlling the physical properties of the low-hardness heat dissipation resin layer.

### CROSS-REFERENCE TO RELATED APPLICATIONS

This application claims priority under 35 U.S.C. § 119 to Korean Patent Application No. 10-2024-0143636, filed on Oct. 21, 2024, in the Korean Intellectual Property Office, the disclosure of which is incorporated herein by reference in its entirety.

### TECHNICAL FIELD

The following disclosure relates to a battery assembly to which a low-hardness heat dissipation resin layer is applied.

### BACKGROUND

A battery assembly may include a plurality of battery cells which are electrically connected and housed inside a case.

The rapid growth of electric vehicles, hybrid vehicles, and energy storage systems (ESS) is leading to demands for battery assemblies having high energy density.

### SUMMARY

An embodiment of the present disclosure is directed to providing a battery assembly which may effectively release heat, by applying a heat dissipation resin layer having specific physical properties in some exemplary embodiments.

Another embodiment of the present disclosure is directed to providing a battery assembly which may minimize cell damage due to a swelling phenomenon occurring in a battery cell during charging and discharging.

In addition, a cell flow due to vibration and external shock occurring in a car driving environment is suppressed by including a low-hardness heat dissipation resin layer having a shore A hardness of about 40 to 80 between a battery cell and a battery housing, so that external and internal damage to a cell therefrom may be prevented.

Still another embodiment of the present disclosure is directed to providing a battery assembly having improved workability and productivity by adjusting initial viscosity maintenance time and time for developing adhesive strength of a heat dissipation adhesive composition for forming a heat dissipation resin layer to a specific range.

The battery assembly according to an exemplary embodiment of the present disclosure may be widely applied to electric vehicles, battery charging stations, and also a green technology field such as solar power generations and wind power generation using batteries. In addition, the battery assembly according to an exemplary embodiment of the present disclosure suppresses air pollution and greenhouse gas emission and may be used in eco-friendly electric vehicles, hybrid vehicles, and the like for preventing climate change.

In one general aspect, a battery assembly includes: a battery housing including at least one housing plate;
a battery cell assembly including a plurality of cells which are stacked and placed in the battery housing and are electrically connected; and
a heat dissipation resin layer placed between the at least one housing plate and the battery cell assembly,
wherein the heat dissipation resin layer satisfies the following Equations 1 to 3:

$$A = {( \frac{E}{20} )}^{2} + {( \frac{L}{30} )}^{- 0.75} < 7.0 \qquad [ Equation 1 ]$$

wherein A is a softness index of the heat dissipation resin layer, E is a modulus of elasticity at a tensile speed of 5 mm/min in accordance with ASTM D638-14, Type 4, and L is an elongation at a tensile speed of 5 mm/min in accordance with ASTM D638-14, Type 4,

$$T 1 \leq 12 \qquad [ Equation 2 ]$$

wherein T1 is a time when a maximum force reaches 1.0 MPa while applying tension at a constant speed of 12.7 mm/min to a breaking point in shearing force evaluation in accordance with ASTM D1002, and the unit is hours,

$$15 \leq T 2 \leq 60 \qquad [ Equation 3 ]$$

wherein T2 is a time when viscosity increases and doubles as compared with initial viscosity of a heat dissipation adhesive composition for forming the heat dissipation resin layer, and the unit is minutes.

In an exemplary embodiment, in Equation 1, A may be 0.1 to 2.0.

In an exemplary embodiment, in Equation 2, T1 may be 5 to 12.

In an exemplary embodiment, the heat dissipation resin layer may have the elongation at a tensile speed of 5 mm/min in accordance with ASTM D638-14, Type 4 of 30 to 450% and the modulus of elasticity at a tensile speed of 5 mm/min in accordance with ASTM D638-14, Type 4 of 1 to 20 MPa.

In an exemplary embodiment, the heat dissipation resin layer may have a shore A hardness in accordance with ASTM D2240 of 40 to 80.

In an exemplary embodiment, the heat dissipation resin layer may have a thermal conductivity in accordance with ISO 22007-2 of 1 to 3 W/mK.

In an exemplary embodiment, the heat dissipation resin layer may include a base resin, a thermally conductive filler, and a catalyst.

In an exemplary embodiment, the base resin may be any one or a mixture of two or more selected from the group consisting of a urethane-based resin, an epoxy-based resin, a silicon-based resin, an acryl-based resin, an olefin-based resin, and an ethylene vinyl acetate-based resin.

In an exemplary embodiment, the thermally conductive filler may be any one or a mixture of two or more selected from the group consisting of alumina, aluminum hydroxide, silicon nitride, zinc oxide, magnesium oxide, boron nitride, aluminum nitride, and silicon carbide.

In an exemplary embodiment, the catalyst may be included at 0.01 to 0.09 wt %.

In an exemplary embodiment, the battery housing may include at least one plate selected from an upper plate, a lower plate, a side plate, and an end plate.

In an exemplary embodiment, the cell may be a pouch type.

In an exemplary embodiment, the battery assembly may be a battery module or a battery pack.

In another general aspect, a battery pack includes: a battery housing including at least one housing plate;
a plurality of battery modules placed in the battery housing, each battery module including a battery cell assembly which includes a plurality of battery cells electrically connected to each other and placed in the battery housing; and a heat dissipation resin layer placed between the at least one housing plate and the battery cell assembly,
wherein the heat dissipation resin layer satisfies Equations 1 to 3:

$$A = {( \frac{E}{20} )}^{2} + {( \frac{L}{30} )}^{- 0.75} < 7.0 \qquad [ Equation 1 ]$$

wherein A is a softness index of the heat dissipation resin layer, E is a modulus of elasticity at a tensile speed of 5 mm/min in accordance with ASTM D638-14, Type 4, and L is an elongation at a tensile speed of 5 mm/min in accordance with ASTM D638-14, Type 4,

$$T 1 \leq 12 \qquad [ Equation 2 ]$$

wherein T1 is a time when a maximum force reaches 1.0 MPa while applying tension at a constant speed of 12.7 mm/min to a breaking point in shearing force evaluation in accordance with ASTM D1002, and the unit is hours,

$$15 \leq T 2 \leq 60 \qquad [ Equation 3 ]$$

wherein T2 is a time when viscosity increases and doubles as compared with initial viscosity of a heat dissipation adhesive composition for forming the heat dissipation resin layer, and the unit is minutes.

Other features and aspects will be apparent from the following detailed description, the drawings, and the claims.

### BRIEF DESCRIPTION OF THE DRAWINGS

FIG. 1 is a perspective view showing a battery module in which the heat dissipation resin layer according to an exemplary embodiment of the present disclosure is applied to a battery cell.

FIG. 2 is a perspective view showing a battery pack in which the heat dissipation resin layer according to an exemplary embodiment of the present disclosure is applied to a battery cell.

### DETAILED DESCRIPTION OF MAIN ELEMENTS

100: Battery cell assembly
200: Heat dissipation resin layer
300: Battery housing
310: Upper plate
320: End plate
330: Side plate
340: Lower plate
1000: Battery assembly

### DETAILED DESCRIPTION OF EMBODIMENTS

Hereinafter, the present disclosure will be described in detail. However, it is only illustrative and the present disclosure is not limited to the specific embodiments which are illustratively described in the present disclosure.

In addition, unless otherwise defined, all technical terms and scientific terms have the same meanings as those commonly understood by a person skilled in the art to which the present disclosure pertains. The terms used herein are only for effectively describing a certain specific example, and are not intended to limit the present disclosure.

In addition, the singular form used in the specification and claims appended thereto may be intended to include a plural form also, unless otherwise indicated in the context.

In addition, unless particularly described to the contrary, “comprising” any elements will be understood to imply further inclusion of other elements rather than the exclusion of any other elements.

In addition, unless particularly defined, when a layer or member is positioned “on” another layer or member, not only is the layer or member in contact with another layer or member, but also another layer or member exists between two layers or two members.

In addition, when unique manufacture and material allowable errors are suggested in the mentioned meaning, “about”, “substantially”, and the like are used in the meaning of the numerical value or in the meaning close to the numerical value, and are used to prevent the disclosure mentioning a correct or absolute numerical value for better understanding of the present disclosure from being unfairly used by an unconscionable infringer.

In the present specification, a “heat dissipation resin layer” may be used in the same meaning as a “heat dissipation adhesive layer” or a “thermally conductive adhesive layer”.

In the present specification, a “battery assembly” may refer to a “battery module” or a “battery pack”, in some cases.

The present disclosure relates to a battery module to which a low-hardness heat dissipation resin layer, which may have improved workability and productivity, reduce occurrence of uneven surface pressure due to swelling, prevent occurrence of damage inside and outside a battery cell, and provide battery stability against vibration and impact, is applied, and a battery pack including the same.

In order to be formed between battery cell assemblies to structurally fix the battery cells and release heat occurring during charging/discharging, a heat dissipation adhesive composition including a thermally conductive filler is applied between a battery cell assembly and a housing plate (module case) to form a heat dissipation resin layer. It is important for the heat dissipation adhesive composition to have appropriate pot life and curing time. In general, a pot life refers to a time until viscosity doubles as compared with initial viscosity. As the pot life increases, a time from application of the heat dissipation adhesive composition to attachment of a battery cell may be managed to be long, and module manufacturing workability may be increased. On the contrary, as a handling time for maintaining low viscosity of the heat dissipation adhesive composition in order to increase the pot life increases, a reaction between a main agent and a curing agent may be delayed to increase a time to perform adhesive performance and decrease productivity. The handling time refers to a curing time for reaching a level at which structural fixation is allowed without occurrence of flow during transfer. In order to improve productivity, the curing time may be shortened by increasing a curing reaction speed, but the reaction occurs rapidly to decrease the pot life and reduce workability.

Therefore, as a result of studying in order to improve workability and productivity, it was found that a battery assembly having improved workability and productivity may be provided by adjusting initial viscosity maintenance time and time for expressing adhesive strength of a heat dissipation adhesive composition for forming a heat dissipation resin layer to a specific range. In addition, since the heat dissipation resin layer satisfies Equation 1, it was found that a battery assembly which may have improved workability and productivity, simultaneously minimize cell damage between swelling occurring in a battery cell, and improve a module life may be provided.

In the present disclosure, effects of excellent structural performance, excellent reliability (life), excellent stability against vibration/impact during transfer, and excellent application quality may be provided, by providing a heat dissipation resin layer satisfying certain physical properties.

As an exemplary embodiment, the battery assembly according to the present disclosure may include: a battery housing including at least one housing plate; a battery cell assembly including a plurality of cells which are stacked and placed in the battery housing and are electrically connected; and a heat dissipation resin layer placed between the at least one housing plate and the battery cell assembly.

As an exemplary embodiment, the battery housing may include at least one plate selected from an upper plate, a lower plate, a side plate, and an end plate.

In an exemplary embodiment, when the battery housing is a module housing, the battery housing may include only a side plate. Herein, the side plate may be connected with a strap, and the heat dissipation resin layer may be placed between the battery pack and the cell assembly.

In an exemplary embodiment, when the battery housing is a module housing, the battery housing may include a side plate, an upper plate, a lower plate, and an end plate. Herein, the heat dissipation resin layer may be placed at least one of between the side plate and the outermost cell of the cell assembly, between the cell inside the module and the lower plate, and between the cell and the upper plate.

In an exemplary embodiment, the battery housing may be a pack housing. In this case, the heat dissipation resin layer may be placed between the battery pack housing and the cell. The heat dissipation resin layer may be applied on at least a part of the surface in contact with the plate, and if necessary, may be applied on the entire surface.

In an exemplary embodiment, the battery assembly may further include a cooling means. For example, in a battery module having a lower cooling structure in which the cooling means is placed in the lower portion of the module housing, in order to implement electrical insulating properties and/or excellent heat transfer properties, a flow path of a cooling fluid may be formed in or on the housing lower plate.

In an exemplary embodiment, when the battery assembly has high energy density, a high-speed charging/discharging operation may generate a lot of heat. If the heat is not controlled, safety issues may arise. The disclosed technology can be implemented in some exemplary embodiments to provide a battery assembly with excellent heat dissipation performance to allow rapid dispersion of heat produced in the battery assembly and effective dissipation of heat to the outside.

In an exemplary embodiment, a thermally conductive adhesive having high hardness characteristics and excellent mechanical properties may be used as a heat dissipation member. However, there is a risk of occurrence of a swelling phenomenon in which a battery cell swells during the charging and discharging of the battery cell, so that a cell surface may be damaged to cause a battery life decrease.

In order to address these issues, the disclosed technology may be implemented in some exemplary embodiments to provide a heat dissipation member configured to maintain structural stability of a battery assembly and to effectively release heat accumulated in the battery assembly during the use.

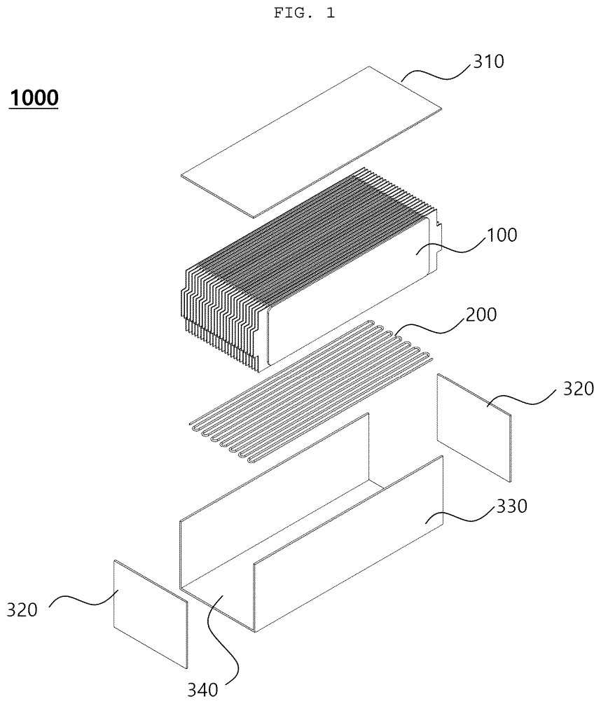

FIG. 1 illustrates a configuration of a battery cell assembly 100 including a plurality of cells, an upper plate 310, an end plate 320, a side plate 330, and a lower plate 340 which form a battery housing, and a heat dissipation resin layer 200, as an exemplary embodiment of the battery assembly according to the present disclosure. Referring to the drawing, the heat dissipation resin layer 200 may be applied between the cell and the lower plate of the module housing. However, the heat dissipation resin layer is not limited to the exemplary embodiment, and may be applied between the side plate and the outermost cell of the cell assembly and/or between the cell in the module and the upper plate. Specifically, the heat dissipation resin layer may be formed by application on a part or all of the surface in contact with the battery cell. A high-hardness or high-strength thermally conductive adhesive which is conventionally applied to a battery module may cause damage to the outside and inside of the cell, which may eventually cause battery life reduction. However, the battery assembly according to the present disclosure has the heat dissipation resin layer including the low-hardness heat dissipation adhesive, thereby effectively releasing heat produced in each cell and minimizing damage outside the cell and damage inside the cell to improve the life and stability of the battery module.

As an exemplary embodiment, the heat dissipation resin layer satisfies the following Equations 1 to 3 simultaneously, and when these are satisfied simultaneously, the effects of excellent structural performance, life, stability against vibration/impact during transfer, and application quality of a battery may be simultaneously satisfied:

$$A = {( \frac{E}{20} )}^{2} + {( \frac{L}{30} )}^{- 0.75} < 7.0 \qquad [ Equation 1 ]$$

wherein A is a softness index of the heat dissipation resin layer, E is a modulus of elasticity at a tensile speed of 5 mm/min in accordance with ASTM D638-14, Type 4, and L is an elongation at a tensile speed of 5 mm/min in accordance with ASTM D638-14, Type 4,

$$T 1 \leq 12 \qquad [ Equation 2 ]$$

wherein T1 is a time when a maximum force reaches 1.0 MPa while applying tension at a constant speed of 12.7 mm/min to a breaking point in shearing force evaluation in accordance with ASTM D1002, and the unit is hours,

$$15 \leq T 2 \leq 60 \qquad [ Equation 3 ]$$

wherein T2 is a time when viscosity increases and doubles as compared with initial viscosity of a heat dissipation adhesive composition for forming the heat dissipation resin layer, and the unit is minutes.

Within the range satisfying the Equations 1 to 3 simultaneously, an excellent heat dissipation function and a structural adhesive function are simultaneously implemented, thereby having an excellent effect of preventing damage to the outside and inside of the cell even under an environment to which external vibration or shock is applied, there is no damage to a battery even in 800 to 1200 cycles of a charge and discharge test in reliability evaluation, stability against vibration/impact during transfer is excellent, application quality is excellent, and eventually, it may contribute to improvement of a battery life and stability.

In an exemplary embodiment, in Equation 1, A may be less than 7.0, 6.9 or less, 6.0 or less, 5.0 or less, 4.0 or less, 3.0 or less, 2.0 or less, 1.5 or less, 1.4 or less, or 1.3 or less and 0.1 or more, 0.2 or more, 0.3 or more, 0.4 or more, 0.5 or more, 0.6 or more, 0.7 or more, 0.8 or more, or 0.9 or more, or any value between the numerical values. For example, A may be 0.1 or more and less than 7.0, 0.1 to 6.0, 0.1 to 5.0, 0.1 to 4.0, 0.1 to 3.0, 0.1 to 2.0, 0.3 to 2.0, 0.3 to 1.5, 0.3 to 1.4, or 0.6 to 1.5, but is not limited thereto. Within the range satisfying Equation 1, structural adhesive performance to allow prevention of a battery cell flow from vibration and external shock may be implemented.

In an exemplary embodiment, as the modulus of elasticity of the heat dissipation resin layer decreases, a battery cycle life may be improved, but the heat dissipation resin layer is too vulnerable to vibration and shock to correspond to the volume change of the battery cell, and thus, a range of the modulus of elasticity needs to be limited so that excellent durability may be secured to a level at which the battery cycle life is not impaired. In addition, when both the elongation and the modulus of elasticity are low, the heat dissipation resin layer is highly likely to be broken and may cause degradation of structural performance of the battery, and thus, excellent impact resistance needs to be secured, and a range of the elongation needs to be limited to a level at which degradation of structural performance of the battery is not caused. Therefore, the present disclosure may provide a battery assembly to which a heat dissipation resin layer having optimized physical properties, which may implement excellent durability, and the extended life and improved stability of a battery, while satisfying a predetermined shear strength value, is applied, by expressing a correlation between the modulus of elasticity and the elongation as the softness index value A and appropriately controlling the value, as shown in Equation 1.

In an exemplary embodiment, in Equation 2, T1 may be 12 hours or less, 11 hours or less, or 10 hours or less and 5 hours or more, 6 hours or more, or 8 hours or more, or any value between the numerical values. For example, T1 may be 5 to 12 hours, 5 to 11 hours, or 6 to 10 hours, but is not limited thereto. Within the range satisfying Equation 2, excellent adhesive strength may be exhibited to provide structural stability and improve workability and productivity during manufacture of a battery assembly. In addition, when T1 is more than 12 hours, bubble may occur in the heat dissipation resin layer in the process of transferring the battery assembly, an application amount may change, or voltage abnormality of a module may occur. The method for measuring T1 will be described in more detail in the Evaluation method of physical properties of the examples described later.

In an exemplary embodiment, in Equation 3, T2 may be 15 to 60 minutes, and within the range, workability and productivity may be improved during manufacture of the battery assembly. When T2 is less than 15 minutes, workability may be deteriorated, for example, a curing speed is high, so that a sufficient time for application is not imparted to deteriorate application quality. In addition, when T2 is more than 60 minutes, sufficient curing is not performed, so that bubble may occur in the heat dissipation resin layer in the process of transferring the battery assembly, an application amount may change, or voltage abnormality of a module may occur. The method for measuring T2 will be described in more detail in the Evaluation method of physical properties of the examples described later.

In an exemplary embodiment, the heat dissipation resin layer may have the elongation at a tensile speed of 5 mm/min in accordance with ASTM D638-14, Type 4 of 30% or more, 40% or more, 50% or more, 60% or more, 70% or more, 80% or more, or 90% or more and 450% or less, 400% or less, 350% or less, 300% or less, 280% or less, 250% or less, 230% or less, or 220% or less, or any value between the numerical values. For example, the elongation may be 30 to 450%, 30 to 400%, 30 to 350%, 30 to 300%, 30 to 280%, 30 to 250%, 30 to 220%, 30 to 200%, 30 to 130%, or 60 to 130%, but is not limited thereto.

In an exemplary embodiment, the heat dissipation resin layer may have the modulus of elasticity at a tensile speed of 5 mm/min in accordance with ASTM D638-14, Type 4 of 1 MPa or more, 2 MPa or more, 3 MPa or more, 4 MPa or more, 5 MPa or more, 6 MPa or more, or 10 MPa or more and 20 MPa or less, or 15 MPa or less, or any value between the numerical values. For example, the modulus of elasticity may be 1 to 20 MPa or 2 to 20 MPa, but is not limited thereto.

In an exemplary embodiment, the heat dissipation resin layer may have a hardness in a shore A type measured in accordance with ASTM D2240 of 90 or less, 85 or less, 80 or less, 75 or less, or 70 or less and 40 or more, 50 or more, or 60 or more, or any value between the numerical values. For example, the hardness may be 40 to 90, 40 to 85, 40 to 80, 40 to 75, 40 to 70, or 60 to 70, but is not limited thereto, Within the range, cell damage may be minimized and the durability of the heat dissipation resin layer may be secured.

In an exemplary embodiment, the heat dissipation resin layer may have a thermal conductivity in accordance with ISO 22007-2 of 1 W/mK or more, 1.5 W/mK or more, or 2 W/mK or more and 3 W/mK or less, or 2.5 W/Mk or less, or any value between the numerical values. For example, the thermal conductivity may be 1 to 3 W/mK or 1 to 2 W/mK, but is not limited thereto. Within the range, the extended life and improved stability of a battery may be implemented.

The heat dissipation resin layer according to an exemplary embodiment of the present disclosure may satisfy the Equations 1 to 3, and may satisfy the modulus of elasticity, the elongation, and the shear strength simultaneously. The battery module or battery pack to which the heat dissipation resin layer satisfying the above physical properties is applied may have an excellent structural stability even in a situation where there is an external vibration and shock, and may exhibit an excellent effect of improving surface pressure during swelling and preventing damage to a cell surface.

In an exemplary embodiment, the heat dissipation resin layer may be formed by applying and curing a heat dissipation adhesive composition. In an exemplary embodiment, the heat dissipation adhesive composition may include a base resin, a thermally conductive filler, and a catalyst and is commonly used in the art, and is not limited as long as the Equations 1 to 3 are satisfied simultaneously. In addition, the heat dissipation resin layer formed by applying the heat dissipation adhesive composition may include a base resin, a thermally conductive filler, and a catalyst.

In an exemplary embodiment, the base resin may include at least one selected from the group consisting of a urethane-based resin, an epoxy-based resin, a silicon-based resin, an acryl-based resin, an olefin-based resin, and an ethylene vinyl acetate-based resin, but is not limited thereto.

The urethane-based resin may be formed, specifically by mixing at least one hydroxyl group-containing compound and isocyanate. This is a two-component polyurethane and is distinguished from a one-component polyurethane having a urethane group in a single composition. The two-component polyurethane may be produced by reacting and curing a main agent including at least one hydroxyl group-containing compound and a curing agent selected from an aliphatic isocyanate, a cycloaliphatic isocyanate, and an aromatic isocyanate at room temperature. Herein, the term “room temperature” refers to a state of a material which is not particularly heated or cooled, and specifically, may refer to any one temperature in a range of 10° C. to 30° C., for example, a temperature of 15° C. or higher, 18° C. or higher, 20° C. or higher, or 23° C. or higher and 27° C. or lower.

As an example, the curing reaction may be performed by using a catalyst such as dibutyltin dilaurate (DBTDL). The two-component polyurethane composition may include a physical mixture of a main agent component and a curing agent component, and may include a reacted product (cured product) of a main agent component and a curing agent component.

The at least one hydroxyl group-containing compound may be monool, diol, triol, or polyol. Specifically, for example, the at least one hydroxyl group-containing compound may be selected from glycols including ethylene glycol (EG), propylene glycol (PG), 1,3-butanediol (1,3-BD), 1,4-butanediol (1,4-BD), neopentyl glycol (NPG), diethylene glycol (DEG), 3-methyl-1,5-pentanediol (MPD), or 1,6-hexanediol (1,6-HD); triols including trimethylolpropane (TMP) or glycerin; tetraols including pentaerythritol; polyether polyols including polyethylene glycol (PEG), polypropylene glycol (PPG), polyoxypropylene triol (GP), or polytetramethylene glycol (PTMG); polyester polyols which are a polycondensate of a basic acid including adipic acid, sebasic acid, or isophthalic acid with the glycols, or polyester polyols including polycaprolactone polyol. More specifically, the at least one hydroxyl group-containing compound may be selected from aromatic polyester polyols exemplified by a polycondensate of isophthalic acid with the glycols; and aliphatic polyester polyols exemplified by polycaprolactone polyol or poly(1,4-butanediol adipate).

In an exemplary embodiment of the present disclosure, the at least one hydroxyl group-containing compound may be a polyether polyol or a mixture thereof. As a non-limiting example, the at least one hydroxyl group-containing compound may include poly(tetramethylene oxide glycol), polypropylene glycol, and a variant thereof.

The isocyanate may be a polyfunctional isocyanate, for example, diisocyanate, triisocyanate, and the like, and may be aliphatic, alicyclic, or aromatic isocyanate. Specifically, the isocyanate may be ethylene diisocyanate; hexamethylene-1,6-diisocyanate (HDI); isophorone diisocyanate (IPDI); 4,4′-, 2,2′-, and 2,4′-dicyclohexylmethane diisocyanate (H12MDI); norbornene diisocyanate; 1,3- and 1,4-(bisisocyanatomethyl)cyclohexane (including cis- or trans-isomers thereof); tetramethylene-1,4-diisocyanate (TMXDI); 1,12-dodecane diisocyanate; 2,2,4-trimethylhexamethylene diisocyanate; 2,2′-, 2,4′-, and 4,4′-methylenediphenyl diisocyanate (MDI); carbodimide-modified MDI; 2,4- and 2,6-toluene diisocyanate (TDI); 1,3- and 1,4-phenylene diisocyanate; 1,5-naphthalene diisocyanate; triphenylmethane-4,4′,4″-triisocyanate; or polyphenylpolymethylene polyisocyanate.

The silicon-based resin may refer to a polymer compound including a siloxane bond as a main skeleton. Specifically, for example, the silicon-based resin may be a polydimethylsiloxane resin or may be produced by reacting and curing a main agent including a polydimethylsiloxane-based polymer and a curing agent at room temperature. For example, the polydimethylsiloxane-based polymer may be a divinylmethyl group-terminated polydimethylsiloxane, and the curing agent may be a dimethylsiloxane-methylhydrogensiloxane copolymer.

The thermally conductive filler may be any one selected from the group consisting of alumina, aluminum hydroxide, silicon nitride, zinc oxide, magnesium oxide, boron nitride, aluminum nitride, and silicon carbide, but is not limited thereto. The form or ratio of the thermally conductive filler is not particularly limited, and may be appropriately adjusted considering the viscosity of the heat dissipation adhesive composition, a sedimentation possibility in a cured resin layer, thermal resistance, thermal conductivity, or dispersibility of the composition, or the like.

In an exemplary embodiment, the thermally conductive filler may be a mixture of alumina and aluminum hydroxide. Without being limited, alumina:aluminum hydroxide may be used in a mixture at a weight ratio of 10 to 90:90 to 10 or 20 to 80:80 to 20.

The heat dissipation resin layer may be formed by curing a heat dissipation adhesive composition in which the urethane-based resin, the catalyst, and the thermally conductive filler are mixed or a heat dissipation adhesive composition in which the silicon-based resin, the catalyst, and the thermally conductive filler are mixed at room temperature for a certain period of time. Otherwise, heat may be applied for a certain period of time to promote curing, to a level at which the thermal stability of the cell is not impaired. For example, heat in a range of lower than 60° C., specifically 30° C. to 50° C. may be applied, before the curing or during the curing process, before the storage or during the storage of the battery cell.

Herein, in an exemplary embodiment, the thermally conductive filler may be used at 100 to 800 parts by weight, 100 to 700 parts by weight, 100 to 600 parts by weight, 100 to 500 parts by weight, 150 to 500 parts by weight, 180 to 500 parts by weight, 200 to 500 parts by weight, 220 to 500 parts by weight, 300 to 500 parts by weight, or 300 to 400 parts by weight, with respect to 100 parts by weight of the resin component, but is not limited thereto.

The catalyst may be selected depending on the types of the main agent and the curing agent and used, and the type or content thereof is not limited as long as Equations 1 to 3 are satisfied. For example, the catalyst may be any one or a mixture of two or more selected from the group consisting of a tin-based catalyst and/or a bismuth-based catalyst, and the like. For example, dibutyltin dilaurate (DBTDL), bismuth octoate, and the like may be used, but is not limited thereto. The content of the catalyst is not limited as long as Equations 1 to 3 are satisfied, but, for example, may be 0.01 to 0.1 wt %, 0.01 to 0.09 wt %, 0.01 to 0.08 wt %, or 0.01 to 0.06 wt % of the total composition, but is not limited thereto.

In an exemplary embodiment, the heat dissipation adhesive composition may further include a viscosity modifier, for example, a thixotropic agent, a diluent, a dispersant, a surface treatment agent, a coupling agent, or the like for adjusting viscosity, for example, increasing or decreasing viscosity, or adjusting viscosity depending on shearing force.

The thixotropic agent may adjust viscosity depending on the shearing force of the heat dissipation adhesive composition to allow the manufacturing process of the battery module to be effectively done. Specifically, an example of the thixotropic agent may be fumed silica and the like.

The diluent or the dispersant is usually used for decreasing the viscosity of the heat dissipation adhesive composition, and various kinds known in the art may be used without limitation as long as the diluent or dispersant may show the action described above.

The surface treatment agent is for treating the surface of the filler introduced to the heat dissipation resin layer, and various kinds known in the art may be used without limitation.

The coupling agent may be used for improving the dispersibility of the thermally conductive filler, such as alumina, and various kinds known in the art may be used without limitation.

Besides, the heat dissipation adhesive composition may further include a flame retardant or a flame retardant auxiliary. In this case, a known flame retardant may be used without particular limitation, and specifically, for example, a flame retardant in a solid filler form or a liquid flame retardant may be applied. The flame retardant may be an organic flame retardant such as melamine cyanurate, an inorganic flame retardant such as magnesium hydroxide, or the like. When an amount of the filler which fills the heat dissipation resin layer is large, liquid type triethyl phosphate (TEP), tris(1,3-chloro-2-propyl)phosphate) (TCPP), and the like may also be used. In addition, a silane coupling agent which may act as a flame retardant enhancer may be added.

The heat dissipation adhesive composition may have a viscosity measured at room temperature of 100,000 cP or more, 110,000 cP or more, 120,000 cP or more, 130,000 cP or more, 140,000 cP or more, 150,000 cP or more, 200,000 cP or more, or 300,000 cP or more and 500,000 cP or less, 480,000 cP or less, 450,000 cP or less, 420,000 cP or less, 400,000 cP or less, or 350,000 cP or less, or any value between the numerical values. For example, the viscosity may be 100,000 cP to 500,000 cP, 130,000 to 500,000 cP, 150,000 to 500,000 cP, 200,000 to 500,000 cP, 250,000 to 450,000 cP, or 250,000 to 420,000 cP, but is not limited thereto. The viscosity is measured based on a rotational speed of 1 rpm/s at 25° C., using a rheometer (Anton-Paar, MCR-92).

In an embodiment, the heat dissipation resin layer including the thermally conductive filler has a thermal conductivity of 1 W/mK or more, specifically 1 to 3 W/mk and may increase battery cell cooling efficiency of a cooling means.

In an exemplary embodiment, the heat dissipation resin layer may be applied between the cell and the side plate of the housing, between the cell and the lower plate of the housing, or between the cell and the upper plate of the housing. Herein, the thickness of the heat dissipation resin layer is not particularly limited, but may be specifically 0.1 to 20 mm, 0.2 to 10 mm, or 0.3 to 5 mm.

FIG. 1 illustrates a heat dissipation resin layer 200 which is placed in an applied state between a battery cell assembly 100 and a lower plate 340 included in a battery assembly 1000 according to the present disclosure.

The heat dissipation resin layer 200 may be a means which provides at least one characteristic of insulation, adhesion, and thermal conduction, and in addition to the form illustrated in FIG. 1, may be applied between an outermost cell and the side plate of the housing or between the upper plate of the housing and the cell. In addition, the heat dissipation resin layer may be a fully applied form, in addition to a serpentine shape as illustrated in FIG. 1.

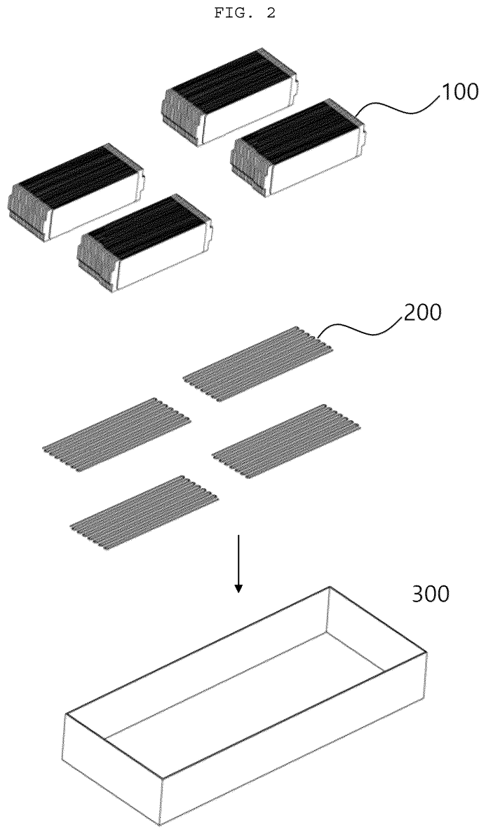

FIG. 2 illustrates an exemplary embodiment in which a heat dissipation resin layer is mounted between a battery cell assembly 100 and a battery pack included in a battery assembly 1000 according to the present disclosure. In this case, a module-less or cell to pack method may be applied, and the heat dissipation resin layer may be placed at least one of between the upper plate of the battery housing and the cell, between the lower plate and the cell, between the side plate and the cell, and between the end plate and the cell.

According to the present disclosure, specifically adhesive strength may be confirmed by measuring shear strength in accordance with ASTM D1002, and a shear strength of 0.2 MPa or more or 0.5 MPa or more may be secured. More specifically, the adhesive strength may be 0.2 to 5.0 MPa or 0.5 to 3.0 MPa. In this case, excellent adhesive performance may be provided for various materials such as a case, a battery cell, a battery pack, and a vehicle chassis to which the battery pack is applied included in the battery module, and since exfoliation of the heat dissipation resin layer and the like are prevented even with volume change of the battery cell due to gassing during charging and discharging, durability is excellent.

In the present disclosure, the battery cell forming the battery module may be a pouch type cell.

The battery cell undergoes a volume change by intercalation and deintercalation of an electrode material during charging and discharging, and when the volume expansion of the battery cell is severe, a pouch type case may be damaged and even when gas eruption or explosion occurs, direct damage may be applied even to an adjacent cell.

The heat dissipation adhesive composition according to the present disclosure is injected into the case of the battery module and brought into contact with one or more battery cells in the battery module, thereby fixing the battery cell in the module case. Specifically, the heat dissipation adhesive composition may be applied at least one selected from between the cell and the side plate of the housing; between the lower plate of the housing and the cell; and between the upper plate of the housing and the cell. The heat dissipation resin layer formed after applying the composition partly or fully between the cell and curing it and the plate prevents a cell flow against shock and vibration, prevents damage to the outside and inside of the cell due to external shock and vibration, and effectively releases heat produced during charging and discharging to prevent the problems described above.

In addition, the present disclosure may provide a battery pack including two or more of the battery modules. The battery modules in the battery pack may be electrically connected. Herein, the heat dissipation adhesive composition may be applied on the inside of the battery pack for fixing the module and effectively transferring heat.

In an exemplary embodiment, a battery pack including: a battery housing including at least one housing plate;
a plurality of battery modules placed in the battery housing, each battery module including a battery cell assembly which includes a plurality of battery cells electrically connected to each other and placed in the battery housing; and a heat dissipation resin layer placed between the at least one housing plate and the battery cell assembly,
wherein the heat dissipation resin layer satisfies the following Equations 1 to 3:

$$A = {( \frac{E}{20} )}^{2} + {( \frac{L}{30} )}^{- 0.75} < 7.0 \qquad [ Equation 1 ]$$

wherein A is a softness index of the heat dissipation resin layer, E is a modulus of elasticity at a tensile speed of 5 mm/min in accordance with ASTM D638-14, Type 4, and L is an elongation at a tensile speed of 5 mm/min in accordance with ASTM D638-14, Type 4,

$$T 1 \leq 12 \qquad [ Equation 2 ]$$

wherein T1 is a time when a maximum force reaches 1.0 MPa while applying tension at a constant speed of 12.7 mm/min to a breaking point in shearing force evaluation in accordance with ASTM D1002, and the unit is hours,

$$15 \leq T 2 \leq 60 \qquad [ Equation 3 ]$$

wherein T2 is a time when viscosity increases and doubles as compared with initial viscosity of a heat dissipation adhesive composition for forming the heat dissipation resin layer, and the unit is minutes.

The battery pack may be used in devices of all purposes requiring a secondary battery as an output. As a specific example, electric vehicles or hybrid cars may be mentioned, but the present disclosure is not limited thereto.

Hereinafter, the examples of the present disclosure will be further described with reference to the specific experimental examples. It is apparent to those skilled in the art that the examples and the comparative examples included in the experimental examples are only for illustrating the present disclosure and do not limit the appended claims, and various modifications and alterations of the examples may be made within the range of the scope and spirit of the present disclosure, and these modifications and alterations will fall within the appended claims.

### (Evaluation Method of Physical Properties)

### 1. Measurement of Modulus of Elasticity and Elongation

Evaluation was performed in accordance with ASTM D638-14, and a type 4 specimen having a thickness of 3 mm was manufactured. A tensile speed was 5 mm/min, the specimen was tensioned at a constant speed until a breaking point, and force and strain measured therefrom were recorded. The device used in the measurement was Z010 available from ZwickRoell. A modulus of elasticity was calculated using a strain and a stress at a point of 0.5%-3.0%, and an elongation was recorded as a value at a breaking point of the specimen.

### 2. Measurement of Hardness

Evaluation was performed in accordance with ASTM D2240, and a flat specimen having a width of 25 mm, a length of 25 mm, and a thickness of 5 mm or more was manufactured. Measurement was performed using hardness measuring equipment (TECLOCK, product name: GS-719G) with a shore A unit, and hardness was evaluated by a value stabilized after 20 seconds of pressing a specimen surface, and 5 points of the specimen were measured, and their average was recorded.

### 3. Measurement of Initial Shear Strength

Shear strength was measured for adhesive strength evaluation.

Evaluation was performed in accordance with ASTM D1002, and a flat plate having a width of 25 mm and a length of 100 mm was manufactured with an aluminum case having an insulation film formed, a heat dissipation resin layer was applied on the flat plate with a thickness of 0.3 mm, a width of 25 mm, and a length of 25 mm, and the two flat plates were put together to manufacture a specimen and evaluation was performed. The specimen was cured for 48 hours, fastened to a tensile tester (ZwickRoell, product name: Z010), and tensioned at a constant speed of 12.7 mm/min to a breaking point, and a maximum force measured therefrom was recorded.

### 4. Measurement of Thermal Conductivity

Evaluation was performed in accordance with ISO 22007-2, and a flat specimen having a width of 50 mm, a length of 50 mm, and a thickness of 5 mm was manufactured. A hot disk sensor was placed between the two specimens and stabilized at a reference temperature of 25° C., and then a thermal conductivity was measured.

### 5. Handling Time

Shearing force was measured in accordance with ASTM D1002, and a flat plate having a width of 25 mm and a length of 100 mm was manufactured with an aluminum case having an insulation film formed, a heat dissipation resin layer was applied on the flat plate with a thickness of 0.3 mm, a width of 25 mm, and a length of 25 mm, the two flat plates were put together to manufacture a specimen, and evaluation was performed. The specimen was cured for a certain period of time after applying the heat dissipation resin layer, fastened to a tensile tester, and tensioned at a constant speed of 12.7 mm/min to a breaking point, and a time when a measured maximum force reached 1.0 MPa was recorded as a handling time.

### 6. Pot Life

Viscosity was measured according to the standard of ASTM D2196. A sample was directly collected from the one-component heat dissipation adhesive composition and the viscosity was measured, and in the case of the two-component heat dissipation adhesive composition, viscosity after mixing the main agent and the curing agent was measured. The viscosity was measured based on a shear rate of 1 rpm/s, using an instrument of Anton-Paar, MCR-92, and a time when viscosity increased and doubled as compared with the initial viscosity was recorded as a pot life.

### (Method of Evaluating Battery Module)

### 1. Evaluation of Battery Structural Performance

A battery module was fastened to an impact tester (available from ETS), an impact load in each axis direction of the module of about 30 to 50 G was applied, and then the battery module was fastened to a vibration tester (Shinken) to apply a vibration load of about 0.5 to 2.0 G within 10 to 200 Hz. After evaluating vibration and impact, it was confirmed whether the outside of the module was damaged, whether the heat dissipation resin layer was cracked or broken, or whether a module voltage was abnormal. The results are shown in the following Table 1.

### <Evaluation Criteria of Structural Performance>

∘: no damage to the outside of the module (such as bolt loosening and damage to module exterior), no crack and breakage in the heat dissipation resin layer, and no abnormal voltage in the module.
x: occurrence of one or more of damage to the outside of the module, crack and breakage in the heat dissipation resin layer, and abnormal voltage in the module.

### 2. Evaluation of Battery Reliability

A fully charged battery module was connected to a charger/discharger (Basytec) in a constant temperature and humidity chamber at 30 to 35° C., and a cycle test was performed with a C-rate of ⅓C and constant charge current and discharge current. Charging and discharging were performed up to 800 to 1200 times, and insulation breakdown of the module and a remaining capacity of the module were measured every 100 cycles. After finishing the charge and discharge test, it was determined whether the insulation of the battery module was broken, a cell electrolyte solution was leaked, cell exterior was damaged, and cell interior was damaged.

### <Evaluation Criteria of Reliability Depending on Cycle>

∘: no insulation breakdown of the battery module, no leakage of cell electrolyte solution, no damage to cell exterior, and no damage to cell interior.
x: one or more of insulation breakdown of the battery module, leakage of cell electrolyte solution, damaged cell exterior, and damaged cell interior.

### 3. Transfer Test Evaluation

A fully charged battery module was manufactured and evaluation was performed. Evaluation was performed by applying a vibration load of about 0.5 to 2.0 G within 10 to 200 Hz for 3 hours to 6 hours, within 10 hours to 12 hours after applying a heat dissipation adhesive composition on the lower plate manufactured with aluminum or insulation painted aluminum in the battery module. After the vibration evaluation, it was confirmed whether bubbles occurred in the battery resin layer in the module, an application amount changed, or there was voltage abnormality in the module.

### <Transfer Test Evaluation Criteria>

∘: No occurrence of bubbles in the battery resin layer in the module, no change in application amount of the battery resin layer in the module, and no voltage abnormality of the module.
x: One or more of occurrence of bubbles in the battery resin layer in the module, change in application amount of the battery resin layer in the module, and occurrence of voltage abnormality of the module.

### 4. Application Quality Evaluation

Application was performed with a straight line having a width of 4 mm, a height of 2 mm, and a length of 500 mm on a flat plate having a width of 300 mm and a length of 600 mm, using two-component or one-component heat dissipation adhesive composition application equipment. An application speed for the evaluation was 200 mm/s to 300 mm/s, and a discharge flow rate was 2 cc/s to 4 cc/s. After having a downtime of about 5 minutes to 10 minutes after the application, a certain amount of 30 cc to 50 cc was discharged, and application was started again. The application was repeated continuously a total of 10 times to 20 times, the applied heat dissipation resin layer was measured for the width, height, and cross section of the applied resin layer on 3 points of a 50 mm point in the straight line as a starting point, a middle point of the application length, and a 50 mm point before the end of the application, with a 3 D microscope.

### <Application Quality Evaluation Criteria>

∘: No occurrence of breakage of the applied heat dissipation resin layer, a uniform application width, and a change in an application amount within ±10%
x: One or more of occurrence of breakage of the applied heat dissipation resin layer, non-uniform application width, and a change in an application amount more than ±10%

### Example 1

### Preparation of Heat Dissipation Adhesive Composition

A two-component urethane-based adhesive composition was used as a base resin component. An aliphatic polyester polyol as a main agent and a cycloaliphatic isocyanate as a curing agent were mixed at an equivalence ratio of 1:1.05 and a volume ratio of 1:1. Polycaprolactone polyol was used as the aliphatic polyester polyol, and isophorone diisocyanate (IPDI) was used as the cycloaliphatic isocyanate.

400 parts by weight of alumina and aluminum hydroxide solid contents (weight ratio of alumina: aluminum hydroxide=2:8) as a thermally conductive filler were mixed based on 100 parts by weight of the base resin.

A dibutyltin dilaurate catalyst (DBTDL CAS 77-58-7) as a catalyst was mixed at 0.01 wt % of the total composition.

The prepared heat dissipation adhesive composition is shown in Table 1, and the physical properties were measured and are shown in the following Table 2.

The prepared heat dissipation adhesive composition was applied to a battery module as a heat dissipation resin layer.

### Manufacture of Battery Module

In order to manufacture a battery module having a shape as shown in FIG. 1, a module case having a lower plate, a side plate, and an upper plate made of aluminum or insulated painted aluminum was used. The heat dissipation adhesive composition prepared above was applied on the lower plate of the aluminum case so that a pouch cell bundle was stored and placed in the module case, as shown in FIG. 1. Thereafter, a bundle in which a plurality of pouch battery cells (10 to 50) were stacked was stored in the module case so that the heat dissipation adhesive composition and the battery cell bundle were in contact, and assembly was performed so that the heat dissipation adhesive composition was pressed by the battery cell bundle to a thickness of the heat dissipation adhesive composition of at least about 1 mm or less. The physical properties of the manufactured battery module were measured and are shown in the following Table 3.

### Example 2

As shown in Table 1, an aliphatic polyester polyol as a main agent and an aliphatic isocyanate as a curing agent were mixed at an equivalence ratio of 1:1.05 and a volume ratio of 1:1. Poly(butanediol adipate) was used as the aliphatic polyester polyol, and hexamethylene-1,6-diisocyanate (HDI) was used as the aliphatic isocyanate.

Alumina and aluminum hydroxide solid contents (weight ratio of alumina: aluminum hydroxide=8:2) were mixed at 300 parts by weight based on 100 parts by weight of the base resin, and bismuth octoate as a catalyst was mixed at 0.06 wt % of the total composition.

The prepared heat dissipation adhesive composition is shown in Table 1, and the physical properties were measured and are shown in the following Table 2.

A battery module was manufactured in the same manner as in Example 1, except that the heat dissipation adhesive composition as such was used.

The physical properties of the prepared heat dissipation adhesive composition and the battery module were measured and are shown in the following Tables 2 and 3.

### Example 3

As shown in Table 1, an aliphatic polyester polyol as a main agent and a cycloaliphatic isocyanate as a curing agent were mixed at an equivalence ratio of 1:1.05 and a volume ratio of 1:1. Poly(butanediol adipate) was used as the aliphatic polyester polyol, and isophorone diisocyanate (IPDI) was used as the cycloaliphatic isocyanate.

Alumina and aluminum hydroxide solid contents (weight ratio of alumina: aluminum hydroxide=5:5) were mixed at 330 parts by weight based on 100 parts by weight of the base resin, and a dibutyltin dilaurate catalyst (DBTDL CAS 77-58-7) as a catalyst was mixed at 0.02 wt % of the total composition.

The prepared heat dissipation adhesive composition is shown in Table 1, and the physical properties were measured and are shown in the following Table 2.

A battery module was manufactured in the same manner as in Example 1, except that the heat dissipation adhesive composition as such was used.

The physical properties of the prepared heat dissipation adhesive composition and the battery module were measured and are shown in the following Tables 2 and 3.

### Comparative Example 1

As shown in the following Table 1, as a two-component urethane-based adhesive, polycarbonate polyol as a main agent and an aromatic isocyanate as a curing agent were mixed at an equivalence ratio of 1:1.05 and a volume ratio of 1:1. 4,4′-Methylenediphenyl diisocyanate (MDI) was used as the aromatic isocyanate.

Alumina and aluminum hydroxide solid contents (weight ratio of alumina: aluminum hydroxide=8:2) were mixed at 400 parts by weight based on 100 parts by weight of the base resin, and a dilaurate catalyst (DBTDL CAS 77-58-7) as a catalyst was mixed at 0.005 wt % of the total composition.

The prepared heat dissipation adhesive composition is shown in Table 1, and the physical properties were measured and are shown in the following Table 2.

A battery module was manufactured in the same manner as in Example 1, except that the heat dissipation adhesive composition as such was used.

The physical properties of the prepared heat dissipation adhesive composition and the battery module were measured and are shown in the following Tables 2 and 3.

### Comparative Example 2

As shown in Table 1, an aliphatic polyester polyol as a main agent and an aliphatic isocyanate as a curing agent were mixed at an equivalence ratio of 1:1.05 and a volume ratio of 1:1. Poly(butanediol adipate) was used as the aliphatic polyester polyol, and hexamethylene-1,6-diisocyanate (HDI) was used as the aliphatic isocyanate.

330 parts by weight of alumina and aluminum hydroxide solid contents (weight ratio of alumina: aluminum hydroxide=2:8) as a thermally conductive filler were mixed based on 100 parts by weight of the base resin. Bismuth octoate as a catalyst was mixed at 0.003 wt % of the total composition.

The prepared heat dissipation adhesive composition is shown in Table 1, and the physical properties were measured and are shown in the following Table 2.

A battery module was manufactured in the same manner as in Example 1, except that the heat dissipation adhesive composition as such was used.

The physical properties of the prepared heat dissipation adhesive composition and the battery module were measured and are shown in the following Tables 2 and 3.

### Comparative Example 3

As shown in Table 1, poly(butanediol adipate) which is an aliphatic polyester polyol as a main agent and isophorone diisocyanate which is a cycloaliphatic isocyanate as a curing agent were mixed at an equivalence ratio of 1:1.05 and a volume ratio of 1:1.

330 parts by weight of alumina and aluminum hydroxide solid contents (weight ratio of alumina: aluminum hydroxide=5:5) as a thermally conductive filler were mixed based on 100 parts by weight of the base resin.

A dibutyltin dilaurate catalyst (DBTDL CAS 77-58-7) as a catalyst was mixed at 0.10 wt % of the total composition.

The prepared heat dissipation adhesive composition is shown in Table 1, and the physical properties were measured and are shown in the following Table 2.

A battery module was manufactured in the same manner as in Example 1, except that the heat dissipation adhesive composition as such was used.

The physical properties of the prepared heat dissipation adhesive composition and the battery module were measured and are shown in the following Tables 2 and 3.

### Comparative Example 4

As shown in the following Table 1, as a two-component urethane-based adhesive, polycarbonate polyol as a main agent and an aromatic isocyanate as a curing agent were mixed at an equivalence ratio of 1:1.05 and a volume ratio of 1:1. 4,4′-Methylenediphenyl diisocyanate (MDI) was used as the aromatic isocyanate.

300 parts by weight of alumina and aluminum hydroxide solid contents (weight ratio of alumina: aluminum hydroxide=8:2) as a thermally conductive filler were mixed based on 100 parts by weight of the base resin. A dibutyltin dilaurate catalyst (DBTDL CAS 77-58-7) as a catalyst was mixed at 0.002 wt % of the total composition.

The prepared heat dissipation adhesive composition is shown in Table 1, and the physical properties were measured and are shown in the following Table 2.

A battery module was manufactured in the same manner as in Example 1, except that the heat dissipation adhesive composition as such was used.

The physical properties of the prepared heat dissipation adhesive composition and the battery module were measured and are shown in the following Tables 2 and 3.

TABLE 1

| | | | | | Catalyst | |
|---|---|---|---|---|---|---|
| | | | | | content | Viscosity |
| | Main agent | Curing agent | Filler | Catalyst | (wt %) | (cP) |
| Example 1 | Aliphatic | Cycloaliphatic | Alumina:aluminum | DBTDL | 0.01 | 400,000 |
| | polyester polyol | isocyanate | hydroxide at a weight | | | |
| | | | ratio of 2:8 | | | |
| Example 2 | Aliphatic | Aliphatic | Alumina:aluminum | Bismuth | 0.06 | 250,000 |
| | polyester polyol | isocyanate | hydroxide at a weight | octoate | | |
| | | | ratio of 8:2 | | | |
| Example 3 | Aliphatic | Cycloaliphatic | Alumina:aluminum | DBTDL | 0.02 | 420,000 |
| | polyester polyol | isocyanate | hydroxide at a weight | | | |
| | | | ratio of 5:5 | | | |
| Comparative | Polycarbonate | Aromatic | Alumina:aluminum | DBTDL | 0.005 | 500,000 |
| Example 1 | polyol | isocyanate | hydroxide at a weight | | | |
| | | | ratio of 8:2 | | | |
| Comparative | Aliphatic | Aliphatic | Alumina:aluminum | Bismuth | 0.003 | 250,000 |
| Example 2 | polyester polyol | isocyanate | hydroxide at a weight | octoate | | |
| | | | ratio of 2:8 | | | |
| Comparative | Aliphatic | Cycloaliphatic | Alumina:aluminum | DBTDL | 0.10 | 200,000 |
| Example 3 | polyester polyol | isocyanate | hydroxide at a weight | | | |
| | | | ratio of 5:5 | | | |
| Comparative | Polycarbonate | Aromatic | Alumina:aluminum | DBTDL | 0.002 | 350,000 |
| Example 4 | polyol | isocyanate | hydroxide at a weight | | | |
| | | | ratio of 8:2 | | | |

TABLE 2

| | | Modulus of | | Handling | Pot life | Softness index A | Thermal |
|---|---|---|---|---|---|---|---|
| | Hardness | elasticity E | Elongation L | time T1 | T2 | (E/20)² + | conductivity |
| | (Shore A) | (MPa) | (%) | (hr) | (min) | (L/30)^{-0.75} | (W/mk) |
| Example 1 | 70 | 20 | 90 | 10 | 60 | 1.44 | 2 |
| Example 2 | 60 | 2 | 60 | 6 | 15 | 0.60 | 1 |
| Example 3 | 70 | 15 | 130 | 8 | 30 | 0.90 | 1 |
| Comparative | 97 | 100 | 10 | 8 | 60 | 27.28 | 2 |
| Example 1 | | | | | | | |
| Comparative | 40 | 1 | 220 | 24 | 90 | 0.23 | 1 |
| Example 2 | | | | | | | |
| Comparative | 70 | 10 | 120 | 4 | 5 | 0.60 | 1 |
| Example 3 | | | | | | | |
| Comparative | 89 | 50 | 20 | 13 | 90 | 7.61 | 1 |
| Example 4 | | | | | | | |

TABLE 3

| | Structural | Reliability | Transfer | Application |
|---|---|---|---|---|
| | performance | (life) | test | quality |
| Example 1 | ∘ | ∘ | ∘ | ∘ |
| Example 2 | ∘ | ∘ | ∘ | ∘ |
| Example 3 | ∘ | ∘ | ∘ | ∘ |
| Comparative | ∘ | x | ∘ | ∘ |
| Example 1 | | | | |
| Comparative | ∘ | ∘ | x | ∘ |
| Example 2 | | | | |
| Comparative | ∘ | ∘ | ∘ | x |
| Example 3 | | | | |
| Comparative | ∘ | x | x | ∘ |
| Example 4 | | | | |

As shown in Tables 1 and 2, it was confirmed that Example 1 to 3 which satisfied the physical properties of a softness index A of the heat dissipation resin layer of less than 7, the handling time T1 of 12 hours or less, and the pot life T2 of 15 to 60 minutes simultaneously satisfied all of structural performance, reliability, transfer test, and application quality test.

As shown in Comparative Examples 1 to 4, it was confirmed that when the softness index A of the heat dissipation resin layer, the handling time, and the pot life were not satisfied simultaneously, all of structural performance, reliability, transfer test, and application quality test were not satisfied.

Since the battery assembly according to an exemplary embodiment of the present disclosure includes a low-hardness heat dissipation resin layer, damage to an outer surface of a cell due to swelling caused during high-speed charging and discharging of a battery may be prevented.

In addition, since the battery assembly includes a low-hardness heat dissipation resin layer satisfying specific ranges of physical properties, deterioration of the heat dissipation resin layer due to a car driving environment over time is prevented, and a cell flow due to vibration and shock occurring during car driving may be prevented.

In addition, the structural safety of the battery assembly may be maintained.

In addition, by minimizing insulation breakdown of a battery assembly or a risk of leakage of a cell electrolyte solution, life extension of the battery assembly may be effectively improved.

In addition, a battery assembly having improved workability and productivity may be provided by adjusting initial viscosity maintenance time and time for developing adhesive strength of a heat dissipation adhesive composition for forming a heat dissipation resin layer to a specific range.

In addition, a battery assembly which has excellent battery structural performance, has no battery damage in 800 to 1200 cycles of a charge/discharge test in reliability evaluation, has excellent stability against vibration/impact during transfer, and has excellent application quality may be provided.

The above description is only an example to which the principle of the present disclosure is applied, and other constitutions may be further included without departing from the scope of the present disclosure.

Hereinabove, although the present disclosure has been described by the specific matters and limited exemplary embodiments in the present disclosure, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit of the present disclosure should not be limited to the above-described exemplary embodiments, and the following claims as well as all modified equally or equivalently to the claims are intended to fall within the scope and spirit of the disclosure.

What is claimed is:

1. A battery assembly comprising:
a battery housing including at least one housing plate;
a battery cell assembly including a plurality of cells which are stacked and placed in the battery housing and are electrically connected; and
a heat dissipation resin layer placed between the at least one housing plate and the battery cell assembly,
wherein the heat dissipation resin layer satisfies the following Equations 1 to 3:
$$A = {( \frac{E}{20} )}^{2} + {( \frac{L}{30} )}^{- 0.75} < 7.0 \qquad [ Equation 1 ]$$
wherein A is a softness index of the heat dissipation resin layer, E is a modulus of elasticity at a tensile speed of 5 mm/min in accordance with ASTM D638-14, Type 4, and L is an elongation at a tensile speed of 5 mm/min in accordance with ASTM D638-14, Type 4,
$$T 1 \leq 12 \qquad [ Equation 2 ]$$
wherein T1 is a time when a maximum force reaches 1.0 MPa while applying tension at a constant speed of 12.7 mm/min to a breaking point in shearing force evaluation in accordance with ASTM D1002, and the unit is hours,
$$15 \leq T 2 \leq 60 \qquad [ Equation 3 ]$$
wherein T2 is a time when viscosity increases and doubles as compared with initial viscosity of a heat dissipation adhesive composition for forming the heat dissipation resin layer, and the unit is minutes.

2. The battery assembly of claim 1, wherein in Equation 1, A is 0.1 to 2.0.

3. The battery assembly of claim 1, wherein in Equation 2, T1 is 5 to 12.

4. The battery assembly of claim 1, wherein the heat dissipation resin layer has the elongation at a tensile speed of 5 mm/min in accordance with ASTM D638-14, Type 4 of 30 to 450% and the modulus of elasticity at a tensile speed of 5 mm/min in accordance with ASTM D638-14, Type 4 of 1 to 20 MPa.

5. The battery assembly of claim 1, wherein the heat dissipation resin layer has a shore A hardness in accordance with ASTM D2240 of 40 to 80.

6. The battery assembly of claim 1, wherein the heat dissipation resin layer has a thermal conductivity in accordance with ISO 22007-2 of 1 to 3 W/mK.

7. The battery assembly of claim 1, wherein the heat dissipation resin layer includes a base resin, a thermally conductive filler, and a catalyst.

8. The battery assembly of claim 7, wherein the base resin is any one or a mixture of two or more selected from the group consisting of a urethane-based resin, an epoxy-based resin, a silicon-based resin, an acryl-based resin, an olefin-based resin, and an ethylene vinyl acetate-based resin.

9. The battery assembly of claim 7, wherein the thermally conductive filler is any one or a mixture of two or more selected from the group consisting of alumina, aluminum hydroxide, silicon nitride, zinc oxide, magnesium oxide, boron nitride, aluminum nitride, and silicon carbide.

10. The battery assembly of claim 7, wherein the catalyst is included at 0.01 to 0.09 wt %.

11. The battery assembly of claim 1, wherein the battery housing includes at least one plate selected from an upper plate, a lower plate, a side plate, and an end plate.

12. The battery assembly of claim 1, wherein the cell is a pouch type.

13. The battery assembly of claim 1, wherein the battery assembly is a battery module or a battery pack.

14. A battery pack comprising:
a battery housing including at least one housing plate;
a plurality of battery modules placed in the battery housing, each battery module including a battery cell assembly which includes a plurality of battery cells electrically connected to each other and placed in the battery housing; and
a heat dissipation resin layer placed between the at least one housing plate and the battery cell assembly,
wherein the heat dissipation resin layer satisfies Equations 1 to 3:
$$A = {( \frac{E}{20} )}^{2} + {( \frac{L}{30} )}^{- 0.75} < 7.0 \qquad [ Equation 1 ]$$
wherein A is a softness index of the heat dissipation resin layer, E is a modulus of elasticity at a tensile speed of 5 mm/min in accordance with ASTM D638-14, Type 4, and L is an elongation at a tensile speed of 5 mm/min in accordance with ASTM D638-14, Type 4,
$$T 1 \leq 12 \qquad [ Equation 2 ]$$
wherein T1 is a time when a maximum force reaches 1.0 MPa while applying tension at a constant speed of 12.7 mm/min to a breaking point in shearing force evaluation in accordance with ASTM D1002, and the unit is hours,
$$15 \leq T 2 \leq 60 \qquad [ Equation 3 ]$$
wherein T2 is a time when viscosity increases and doubles as compared with initial viscosity of a heat dissipation adhesive composition for forming the heat dissipation resin layer, and the unit is minutes.
